(19) United States
(12) Patent Application Publication
(10) Pub. No.: US 2005/0078943 A1
(43) Pub. Date: Apr. 14, 2005

(54) Image playback device and image data reverse playback method

(76) Inventor: Masaru Kimura, Iwaki-city (JP)

Correspondence Address: BRINKS HOFER GILSON & LIONE, P.O. BOX 10395, CHICAGO, IL, 60610, US

(21) Appl. No.: 10/930,737

(22) Filed: Aug. 31, 2004

(30) Foreign Application Priority Data
Sep. 2, 2003 (JP) 2003-309913

(51) Int. Cl. H04N 5/783; G06K 9/36; G06K 9/46

(52) U.S. Cl. 386/68; 386/82

(57) ABSTRACT

A digital versatile disk (DVD) player according to the present invention includes a disk read unit for reading image data (pictures) from a DVD, a track buffer for storing the read image data, an MPEG decoder for decoding the image data, and a control unit for controlling at least the track buffer when the image data is played back reversely. The control unit causes the track buffer to store a GOP or a VOBU to be reversely played back and to output the image data to the MPEG decoder while the image data is maintained in the track buffer.

### BACKGROUND OF THE INVENTION

1. Field of the Invention

The present invention relates to image playback devices for playing back digital image data and to playback methods for reversely playing back compressed image data in the image playback devices.

2. Description of the Related Art

The Motion Picture Expert Group (MPEG) technique is one type of compression method for image data, such as still images and moving images. MPEG-compressed image data is stored in a storage medium, such as a digital versatile disk (DVD), a semiconductor memory, or a hard disk. The image data read from such a recording medium is decoded and is displayed on a display.

MPEG-compressed images include three types of pictures: I-pictures, P-pictures, and B-pictures. For an I-picture, discrete cosine transformation (DCT) and entropy compression are performed. Since the I-picture is compressed in a frame, the I-picture is not related to a previous or subsequent picture.

For a P-picture, motion compensation is performed for an immediately previous I picture or P-picture and a difference is compressed. For a B-picture, motion compensation is performed for a previous I-picture or P-picture and a subsequent I-picture or P-picture in playback order and differences are compressed.

Such pictures are grouped into groups of pictures (GOPs) and are stored in a storage medium, such as a DVD. Each of the GOPs includes a plurality of pictures starting from an I-picture, as shown in FIG. 7. Each of the GOPs includes about fifteen pictures. The playback time of each of the GOPs is about five seconds.

Playback operation of image data stored in MPEG format will now be described. For example, each picture is recorded in a recording order shown in FIG. 8. For forward playback, in a GOP, based on the recording order, an I-picture is decoded, a P1-picture is decoded using the I-picture, and a B1-picture and a B2-picture are decoded using the I-picture and the P1-picture, in that order. The playback order of the pictures is not necessarily the same as the recording order. For example, the I-picture, the B1-picture, the B2-picture, the P1 picture, etc. are played back in that order, as shown in FIG. 8.

In contrast, for performing playback in reverse order or performing reverse playback, in order to display a last stored B4-picture, the P1-picture, the P2-picture, and the I-picture must be decoded in advance. However, since the pictures are recorded in the order shown in FIG. 8, the P1-picture, the P2-picture, and the I-picture cannot be decoded in the reverse direction.

There are two procedures for reverse playback. A first procedure is shown in FIG. 9. An MPEG decoder 100 decodes all the pictures of a GOP read from a disk, such as a DVD, in the forward direction. The decoded pictures of the GOP from the first picture to the last picture are stored in an image memory 110. For reverse playback, the B4-picture decoded last in the image memory 110 is first read. The B4-picture is digital-to-analog (D/A) converted by a video encoder 120 to be displayed as an analog video output on a display.

A second procedure is shown in FIG. 10. A Video object unit (VOBU) including one or more integral GOPs is read from a disk by a driver 210, and the read VOBU is temporarily stored in a first-in-first-out (FIFO) track buffer 220. For reverse playback, the driver 210 searches for a VOBU including a picture to be played back and the found VOBU is read into the track buffer 220. An MPEG decoder 230 decodes the picture in the VOBU (for example, a B4-picture) to be played back. The decoded picture is converted into an analog video output to be displayed on a display. In order to display the next picture, the same VOBU is read again from the disk. The read VOBU is temporarily stored in the track buffer 220. The VOBU is input to the MPEG decoder 230, and the picture (for example, a B3-picture) to be next played back is decoded. Repeating this operation enables reverse playback.

A technology for reversely playing back MPEG image data is disclosed in Japanese Unexamined Patent Application Publication No. 11-136638. A memory for storing image data for one field is provided for each of a plurality of banks. Read bank designation means sequentially designates a bank for reading image data such that the order of playback fields for reverse playback is opposite to the order for forward playback. In this procedure, decoded image data is stored in a plurality of memories. This procedure is similar to the first procedure described above.

However, known reverse playback for MPEG image data has the problems described below. In the first procedure described above, a mass storage memory must be added in order to store decoded pictures. Moreover, a memory controller for controlling the reading operation of the memory is needed. Also, since an image is delayed by the time for accumulation in an image memory (about 0.5 seconds), synchronization between the image and sound must be considered. For example, eight bits are allocated for each of Y (luminance) and Cb and Cr (chrominances) of image data, and the image data is recorded in a format, such as 4: 2: 0. In this case, an image memory having about 50 Mbits (720 (the number of pixels in a horizontal direction)×480 (the number of pixels in a vertical direction)×10 (the number of bits per pixel)×15 (the number of pictures per GOP)=about 50 Mbits) is needed, and cost is thus increased.

In the second procedure described above, after displaying a first picture, a VOBU is read again and then pictures are decoded in a forward direction before displaying a second picture. Thus, a display interval between the pictures is increased. This prevents a smooth slow playback. For example, for a double-speed decoding, the time required for displaying the B3-picture after displaying the B4-picture is 67 milliseconds, which is the decoding time for the I-picture, the P1-picture, the P2-picture, and the B3-picture (1/30×½×4=67 milliseconds), where the next VOBU is read into the track buffer 210. Thus, the same frame must be repeatedly displayed for two frames, and a search time for the driver 210 must be 67 milliseconds or less. Actually, since a search time of about 100 milliseconds is allowed for, the same image is displayed for about three frames. Thus, for half-speed slow playback, a picture is displayed every two pictures, and the same picture is repeated for four frames.

### SUMMARY OF THE INVENTION

In order to solve the above problems, an object of the present invention is to provide an image playback device and an image data reverse playback method capable of performing smooth reverse playback.

Another object of the present invention is to provide an image playback device with a low cost.

An image playback device according to the present invention includes an image data reading unit for reading image data from a recording medium; an image data storage unit capable of storing the read image data; a decoding unit for decoding the image data; and a reverse playback control unit for controlling the image data storage unit when the image data is played back reversely. The reverse playback control unit causes the image data storage unit to output the image data to be reversely played back to the decoding unit while the image data is stored in the image data storage unit.

Preferably, the reverse playback control unit performs write control for writing the image data to be reversely played back in the image data storage unit and performs read control for reading the image data from the image data storage unit. Also, the image data storage unit may store an image data group or an image data block including a plurality of pieces of compressed image data constituting a frame or a field. The image data group or the image data block is, for example, a group of pictures (GOP) or a video object unit (VOBU) including a plurality of MPEG-compressed pictures. The image data group or the image data block may include a plurality of I pictures, P-pictures, or B-pictures.

Preferably, when the decoding unit terminates decoding of image data in a frame or a field, the reverse playback control unit causes the image data group stored in the image data storage unit to be output to the decoding unit.

An image data reverse playback method according to the present invention for reversely playing back image data recorded on a recording medium includes a storing step of searching the recording medium for an image data group to be reversely played back and storing the found image data group into a memory; a first decoding step of reading the image data group from the memory and decoding first image data; and a second decoding step of reading the same image data group from the memory and decoding second image data after decoding the first image data of the image data group.

According to the present invention, in order to reversely play back image data, an image data storage unit for storing the image data is provided and the image data is controlled by a reverse playback control unit to be output to a decoding unit while the image data is stored in the image data storage unit. Thus, the decoding unit uses the image data stored in the image data storage unit every time decoding of the image data is terminated. This reduces a display interval for playing back and displaying the image data and generates a smooth image played back reversely.

### BRIEF DESCRIPTION OF THE DRAWINGS

FIG. 1 is a block diagram showing the structure of a DVD player according to a first embodiment of the present invention;

FIG. 2 is a flowchart for explaining a reverse playback operation according to the first embodiment;

FIG. 3 is a block diagram showing the internal structure of an MPEG decoder according to a second embodiment of the present invention;

FIG. 4 shows the relationship between the MPEG decoder and output pictures when forward playback is performed by a DVD player according to the second embodiment;

FIG. 5 shows the relationship between the MPEG decoder and output pictures when reverse playback is performed by the DVD player according to the second embodiment;

FIG. 6 shows the relationship between an MPEG decoder and output pictures when known reverse playback is performed;

FIG. 7 shows the structure of an MPEG-compressed group of pictures;

FIG. 8 explains a known recording order and playback order for a picture;

FIG. 9 explains a known first reverse playback procedure; and

FIG. 10 explains a known second reverse playback procedure.

### DETAILED DESCRIPTION OF THE PREFERRED EMBODIMENTS

Embodiments of the present invention will be described with reference to the drawings. Preferably, a data playback device according to the present invention is a DVD player.

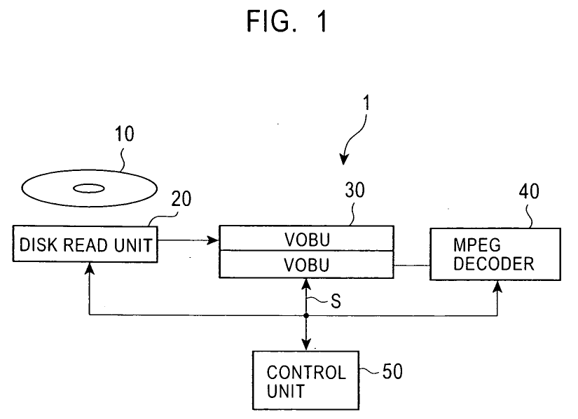

FIG. 1 is a block diagram showing the main structure of a DVD player 1 according to a first embodiment of the present invention. The DVD player 1 includes a disk read unit 20, a track buffer 30, an MPEG decoder 40, and a control unit 50. The disk read unit 20 corresponds to an image data reading unit for reading image data or the like recorded on a DVD 10. The track buffer 30 corresponds to an image data storage unit for storing digital image data output from the disk read unit 20. The MPEG decoder 40 corresponds to a decoding unit for decoding the image data output from the track buffer 30. The control unit 50 controls each of the units and includes a reverse playback control unit.

As is known, the disk read unit 20 includes a read section for optically reading data recorded on the DVD 10 and for converting the read data into an electric signal, an analog-to-digital (A/D) conversion section for amplifying the electric signal and for converting the amplified electric signal into digital data, and the like. In accordance with an instruction from the control unit 50, the disk read unit 20 searches for data recorded in a predetermined track position in the DVD 10, and outputs the read data to the track buffer 30.

Normally, DVD players include a track buffer, which is necessary for seamless angle change, provided upstream of a decoder. The track buffer 30 is a memory for storing image data from the disk read unit 20 in units of GOPs or in units of VOBUs each including a plurality of GOPs. Preferably, two or three VOBUs can be stored in a storage area.

One of the characteristics of the present invention is that the track buffer 30 has a structure different from a known FIFO memory and is capable of storing image data for a desired period under the management of the control unit 50 for reverse playback. If a track buffer is a FIFO memory, image data written from the disk read unit 20 is output to the MPEG decoder 40 and the content of the image data is deleted every time the next image data is written.

However, the track buffer 30 according to the present invention uses a memory in which writing and reading are controlled by the control unit 50. For example, a dynamic memory or a static memory capable of random access is used for the track buffer 30. The control unit 50 outputs a signal S to the track buffer 30. The signal S includes a read and write control signal for instructing reading and writing of image data, an address signal for designating an address of a memory, and the like. Thus, the image data from the disk read unit 20 is written into the track buffer 30 in accordance with the address signal from the control unit 50. Also, the image data written into the track buffer 30 is read in accordance with the address signal from the control unit 50 and is output to the MPEG decoder 40. The image data in the track buffer 30 is maintained unless the image data is overwritten on the same address or unless image data is deleted. If the control unit 50 determines that image data is unnecessary, the original image data is deleted by overwriting new image data. In order to increase the speed of writing and reading of image data into and from the track buffer 30, a synchronous type memory that is synchronized with a clock signal may be used. Furthermore, the track buffer 30 may include an address counter. In this case, a first address supplied from the control unit 50 is set as an initial counter value and is incremented, and image data is sequentially stored in an incremented address.

The MPEG decoder 40 decodes (expands) MPEG-compressed I-pictures, P-pictures, and B-pictures. The decoded pictures are converted into analog video outputs by an encoder (D/A) (not shown) to be displayed on a display.

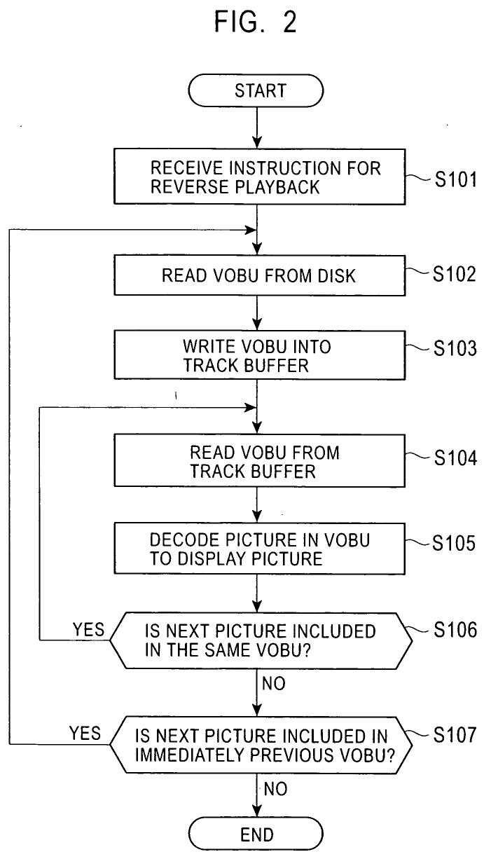

An operation for reverse playback in the first embodiment will now be described with reference to FIG. 2. In the DVD player 1, an instruction for reverse playback is received from a user (step S101). In accordance with the instruction, the control unit 50 causes the disk read unit 20 to search for a VOBU including a picture to be reversely played back and to read the VOBU (step S102). The control unit 50 causes the VOBU read by the disk read unit 20 to be written in a predetermined address in the track buffer 30 (step S103).

The control unit 50 causes the VOBU to be read from the track buffer 30 (step S104). The read VOBU is output to the MPEG decoder 40, and the MPEG decoder 40 performs decoding of a picture necessary for display (step S105). For example, for displaying an I-picture, the I-picture is decoded, and for displaying a P-picture, an immediately previous I-picture or P-picture is decoded and the P-picture is decoded by referring to the decoded I-picture or P-picture. Accordingly, a picture is displayed.

The control unit 50 determines whether or not a picture to be reversely played back is included in the same VOBU (step S106). If the picture is included in the same VOBU, the same VOBU is read again from the track buffer 30, and the read VOBU is output to the MPEG decoder 40. Then, decoding for displaying the next picture is performed (step S105).

If a picture to be displayed next is included in an immediately previous VOBU (step S107), the control unit 50 causes the disk read unit 20 to search for the immediately previous VOBU, and step S102 and the subsequent steps are repeated. If a picture to be displayed next is not included in the immediately previous VOBU, reverse playback is terminated. The control unit 50 may delete the content in the track buffer 30 at this point in time.

According to the first embodiment, a VOBU in the track buffer 30 is not deleted every time a picture is displayed but is maintained in the track buffer 30. Thus, it is unnecessary for a VOBU to be searched for and to be read from the DVD 10 when displaying the next picture. Therefore, a display interval between pictures can be reduced. Since the playback time is at least 800 milliseconds when a VOBU is slowly played back at half speed, reading the immediately previous VOBU into the track buffer 30 during this time eliminates an influence of a search time by the disk read unit 20 near a border of VOBUs.

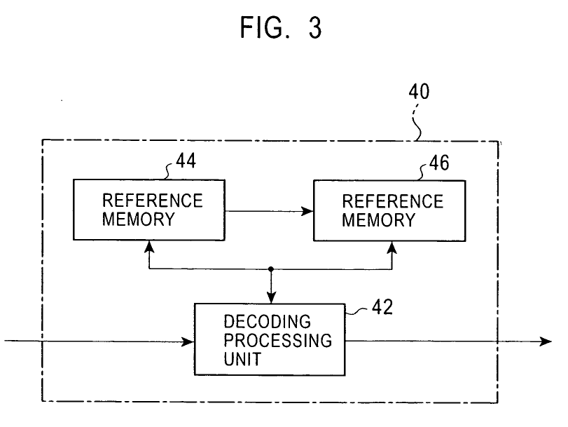

A second embodiment of the present invention will be described. In the second embodiment, as shown in FIG. 3, the MPEG decoder 40 includes a decoding processing unit 42 and reference memories 44 and 46. The decoding processing unit 42 decodes (expands) MPEG-compressed I-pictures, P-pictures, and B-pictures and controls the reference memories 44 and 46. The reference memories 44 and 46 store already decoded I-pictures and P-pictures. When a designated picture in a VOBU or a GOP is sequentially searched for in an MPEG decoder, normally, I-pictures and P-pictures already stored for reference are disposed of. However, in the second embodiment, data of reference pictures stored in the reference memories 44 and 46 is not disposed of. Storing such reference pictures causes a reduction in a time for searching for a designated picture. The decoding processing unit 42 controls deletion and non-deletion of data stored in the reference memories 44 and 46.

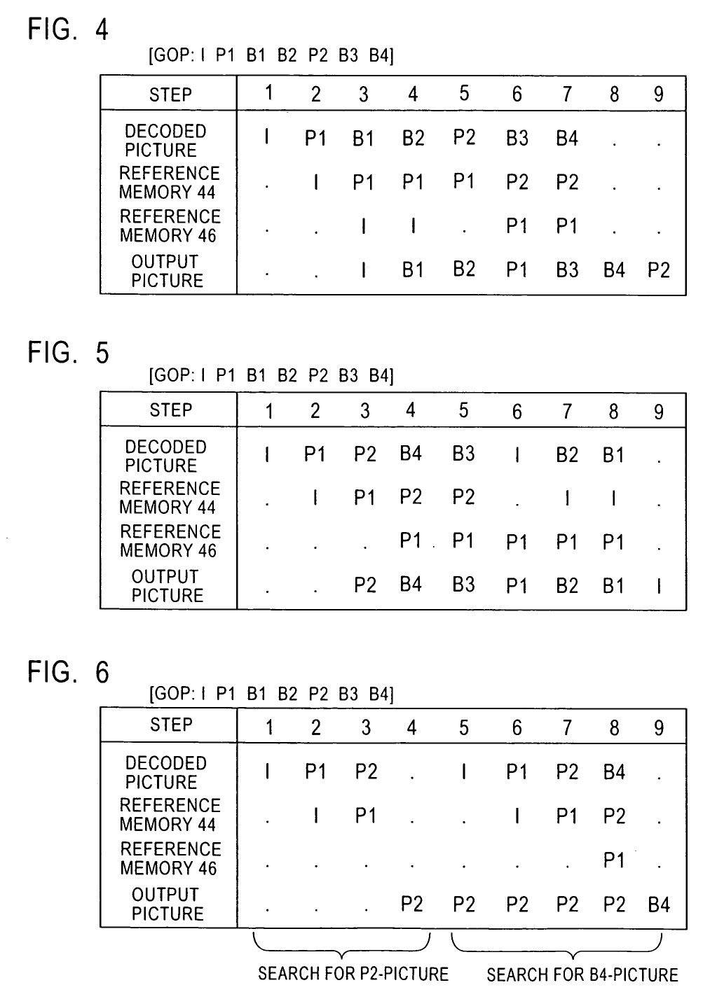

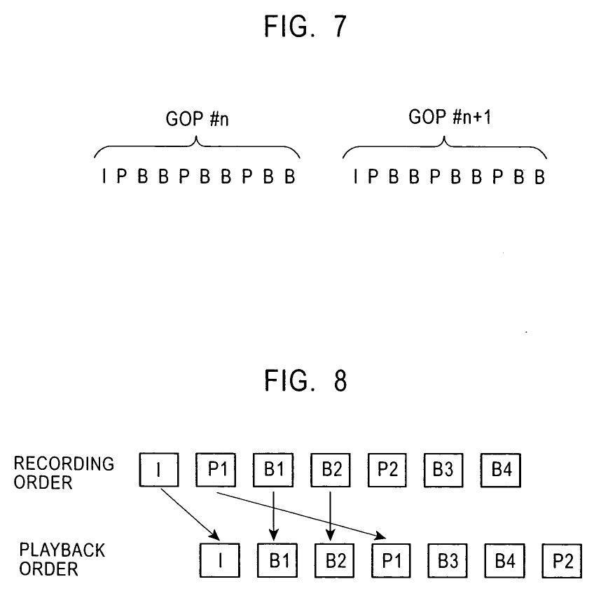

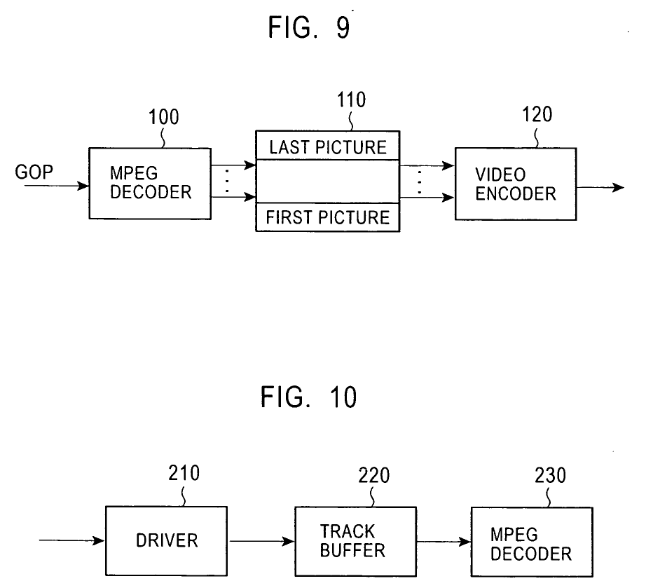

A playback operation according to the second embodiment will now be described. FIG. 4 shows the relationship between the MPEG decoder 40 and output pictures when the DVD player 1 performs forward playback. In the second embodiment, a GOP includes an I-picture, a P1-picture, a B1-picture, a B2-picture, a P2-picture, a B3-picture, and a B4-picture. These pictures are stored in the track buffer 30. The GOP including these pictures is read under the control of the control unit 50, and is output to the decoding processing unit 42 of the MPEG decoder 40.

In step S1, the decoding processing unit 42 decodes a first I-picture. In step S2, the decoded I-picture is stored in the reference memory 44, and the P1-picture is decoded by referring to the I-picture stored in the reference memory 44. In step S3, the I-picture is stored in the reference memory 46 and is displayed as an output picture, and the P1-picture is stored in the reference memory 44. Also, the B I-picture is decoded by referring to the I-picture stored in the reference memory 46 and the P1-picture stored in the reference memory 44.

In step S4, the reference memories 44 and 46 maintain the P1-picture and the I-picture therein, the B2-picture is decoded by referring to the I-picture and the P1-picture, and the B1-picture is output and displayed. In steps S5 to S9, the P2-picture, the B3-picture, and the B4-picture are sequentially decoded, and the B2-picture, the P1-picture, the B3-picture, the B4-picture, and the P2-picture are sequentially played back.

An operation for reverse playback will now be described. FIG. 5 shows the relationship between the MPEG decoder 40 and output pictures in the second embodiment. In step S1, the I-picture is processed by the decoding processing unit 42. In step S2, the I-picture is stored in the reference memory 44, and the P1-picture is decoded by referring to the I-picture. In step S3, the P1-picture is stored in the reference memory 44, the P2-picture is decoded by referring to the P I-picture, and the P2-picture is displayed as an output picture.

In step S4, the P1-picture stored in the reference memory 44 is stored in the reference memory 46, and the P2-picture decoded in step S3 is stored in the reference memory 44. Also, the B4-picture is decoded by referring to the P1-picture and the P2-picture and is displayed as an output picture. In steps S5 to S9, as shown in FIG. 5, the B3-picture, the I-picture, the B2-picture, and the B1-picture are sequentially decoded, and the B3-picture, the P1-picture, the B2-picture, the B I-picture, and the I-picture are sequentially displayed as output pictures. Accordingly, in the second embodiment, by performing steps S1 to S9, the pictures for the forward playback shown in FIG. 3 can be played back in a reverse direction.

FIG. 6 shows the relationship between a decoder and output pictures for known reverse playback. In the known reverse playback, as described above, since a GOP or a VOBU in a FIFO track buffer is deleted every time a picture is displayed, the same GOP or the same VOBU must be read from a DVD. Thus, when reverse playback is performed from the P2-picture, steps S1 to S4 are performed for playback of the P2-picture, and steps S5 to S9 are performed for playback of the B4-picture. Accordingly, only the P2-picture and the B4-picture can be played back during the process from steps S1 to S9.

In other words, in step S1, the I-picture is decoded. In step S2, the I-picture is stored in the reference memory 44, and the P1-picture is decoded using the I-picture. In step S3, the P1-picture is stored in the reference memory 44, and the P2-picture is decoded using the P1-picture. In step S4, the P2-picture is displayed. Then, the same GOP is read from a disk. In step S5, the I-picture is decoded. In step S6, the P1-picture is decoded using the I-picture in the reference memory 44. In step S7, the P2-picture is decoded using the P1-picture in the reference memory 44. In step S8, the B4-picture is decoded using the P1-picture stored in the reference memory 46 and the P2-picture stored in the reference memory 44. During this time, the output picture is the P2-picture. In step S9, the B4-picture is displayed. Accordingly, in the known procedure, five frames are needed for displaying only the P2-picture. For half-speed playback, a picture to be searched for must be partially omitted.

Compared with simply sequentially searching for designated pictures in a GOP, controlling deletion and non-deletion of data of reference pictures stored in the reference memories 44 and 46 and maintaining necessary data in the reference memories 44 and 46 achieves smooth reverse playback, in particular, slow playback.

While the preferred embodiments of the present invention have been described, the present invention is not necessarily limited to each of the embodiments described above. Various changes and modifications may be made to the present invention without departing from the scope and spirit of the present invention as defined by the claims. For example, reverse playback may be performed at the same speed as forward playback. Alternatively, reverse playback may be performed at high speed or low speed.

The present invention is applicable to a playback device for recording digital image data or the like on a recording medium and for playing back the digital image data or the like. The recording medium may be a DVD, a semiconductor memory, a hard disk, or the like. The image data may be MPEG-compressed data or data compressed in other formats.

1. An image playback device comprising:
an image data reading unit for reading image data from a recording medium;
an image data storage unit capable of storing the read image data;
a decoding unit for decoding the image data; and
a reverse playback control unit for controlling the image data storage unit when the image data is played back reversely, wherein
the reverse playback control unit causes the image data storage unit to output the image data to be reversely played back to the decoding unit while the image data is stored in the image data storage unit.

2. The image playback device according to claim 1, wherein the reverse playback control unit performs write control for writing the image data to be reversely played back in a predetermined address in the image data storage unit and performs read control for reading the image data from the image data storage unit.

3. The image playback device according to claim 1, wherein:
the image data storage unit stores an image data group including a plurality of pieces of compressed image data constituting a frame or a field; and
after the decoding unit terminates decoding of a first frame or a first field, the reverse playback control unit causes the image data group stored in the image data storage unit to be output to the decoding unit.

4. The image playback device according to claim 1, wherein:
the decoding unit includes a plurality of reference memories for storing the decoded image data which is referred to when compressed image data is decoded; and
the plurality of reference memories is capable of storing the decoded image data until decoding of an image data group is terminated.

5. The image playback device according to claim 1, wherein until all the image data in an image data group stored in the image data storage unit is decoded by the decoding unit, the reverse playback control unit causes the image data storage unit to store the image data group.

6. The image playback device according to claim 1 wherein:
the image data is MPEG-compressed image data; and
a compressed frame or field is an I-picture, a P-picture, or a B-picture.

7. An image playback device comprising:
an image data reading unit for reading image data from a recording medium;
an image data storage unit capable of storing the read image data;
a decoding unit for decoding the image data; and
a reverse playback control unit for controlling the image data storage unit when the image data is played back reversely, wherein:
the reverse playback control unit performs write control for writing the image data to be reversely played back in a predetermined address in the image data storage unit and performs read control for reading the image data from the image data storage unit;
the image data storage unit stores an image data group including a plurality of pieces of compressed image data constituting a frame or a field; and
after the decoding unit terminates decoding of a first frame or a first field, the reverse playback control unit causes the image data group stored in the image data storage unit to be output to the decoding unit.

8. The image playback device according to claim 7, wherein:
the decoding unit includes a plurality of reference memories for storing the decoded image data which is referred to when the compressed image data is decoded; and
the plurality of reference memories is capable of storing the decoded image data until decoding of the image data group is terminated.

9. The image playback device according to claim 7, wherein until all the image data in the image data group stored in the image data storage unit is decoded by the decoding unit, the reverse playback control unit causes the image data storage unit to store the image data group.

10. The image playback device according to claim 7, wherein:
the image data is MPEG-compressed image data; and
a compressed frame or field is an I-picture, a P-picture, or a B-picture.

11. An image playback device comprising:
an image data reading unit for reading image data from a recording medium;
an image data storage unit capable of storing the read image data;
a decoding unit for decoding the image data; and
a reverse playback control unit for controlling the image data storage unit when the image data is played back reversely, wherein:
the reverse playback control unit performs write control for writing the image data to be reversely played back in a predetermined address in the image data storage unit and performs read control for reading the image data from the image data storage unit;
the decoding unit includes a plurality of reference memories for storing the decoded image data which is referred to when compressed image data is decoded; and
the plurality of reference memories is capable of storing the decoded image data until decoding of an image data group is terminated.

12. The image playback device according to claim 11, wherein until all the image data in the image data group stored in the image data storage unit is decoded by the decoding unit, the reverse playback control unit causes the image data storage unit to store the image data group.

13. The image playback device according to claim 11, wherein:
the image data is MPEG-compressed image data; and
a compressed frame or field is an I-picture, a P-picture, or a B-picture.

14. An image data reverse playback method for reversely playing back image data recorded on a recording medium, comprising:
a storing act of searching the recording medium for an image data group to be reversely played back and storing the found image data group into a memory;
a first decoding act of reading the image data group from the memory and decoding first image data; and
a second decoding act of reading the same image data group and decoding second image data after decoding the first image data.

15. The image data reverse playback method according to claim 14, further comprising a playback act of sequentially playing back the decoded image data.

16. The image data reverse playback method according to claim 15, wherein the first and second decoding acts include a referring act of referring to the decoded image data stored in a reference memory.

17. The image data reverse playback method according to claim 15, wherein the image data group is stored in the memory until reverse playback of the image data group is terminated.

18. The image data reverse playback method according to claim 15, wherein the image data group includes a plurality of MPEG-compressed I-pictures, P-pictures, or B-pictures.
